(19) United States
(12) Patent Application Publication
(10) Pub. No.: US 2013/0040657 A1
(43) Pub. Date: Feb. 14, 2013

(54) ELECTRONIC DOCUMENT READING DEVICES

(71) Applicant: Martin Jackson, Cambridge, Cambridgeshire (GB)

(72) Inventor: Martin Jackson, Cambridge, Cambridgeshire (GB)

(73) Assignee: Plastic Logic Limited, Cambridge, Cambridgeshire (GB)

(21) Appl. No.: 13/520,336

(22) PCT Filed: Dec. 24, 2010
(86) PCT No.: PCT/GB2010/052212

§ 371 Date: Oct. 26, 2012

(30) Foreign Application Priority Data
Jan. 4, 2010 (GB) 1000021.4

(51) Int. Cl. H04W 4/02; G09G 3/34

(52) U.S. Cl. 455/456.1; 345/107

(57) ABSTRACT

We describe an electronic document reading device comprising: a wireless remote content connection; a physical user interface for receiving device control commands from a user; non-volatile data storage; a non-volatile electrophoretic display screen; and a device controller. The controller has program code to: read an item of electronic document content from said non-volatile data store; wherein the item of electronic document content includes: i) electronic document content display data, ii) a location based permission control object configured to define allowed location-based display of the content display data on the electrophoretic display; determine a physical location of the reading device; and operate with the permission control object to determine whether display of the content display data is permitted at the physical location, wherein operating with the permission control object enables the item of electronic document content to control whether its own content is displayed on the non-volatile electrophoretic display screen.

### FIELD OF THE INVENTION

This invention relates to electronic document reading devices, in particular of the type having a permanent (non-volatile) display screen such as an electrophoretic display screen. More particularly aspects of the invention relate to document security techniques for such devices.

### BACKGROUND TO THE INVENTION

We have previously described electronic document reading devices using an electrophoretic display with a flexible or flex-tolerant backplane based on plastic (solution-deposited) electronics, for example in our earlier applications PCT/GB2006/050235, PCT/GB2008/050980, PCT/GB2008/050977, PCT/GB2008/050985, PCT/GB2008/050985, PCT/GB2008/050985, PCT/GB2009/050144 and PCT/GB2009/051071, all hereby incorporated by reference. We have described an electronic document reading device with a touch sensitive display using resistive touch screen technology in WO2007/012899, and a device using projected capacitance touch sensing in GB0916806.3 (PCT/GB2010/051601).

Background prior art relating to electronic document reading devices can be found in U.S. Pat. No. 6,124,851, US2004/0201633, US2006/0133664, US2006/0125802, US2006/0139308, US2006/0077190, US2005/0260551, U.S. Pat. No. 6,124,851, U.S. Pat. No. 6,021,306, US2005/0151742, and US2006/0119615. Examples of electronic document reading devices are the Iliad Ilex (®), the Amazon Kindle (®) and the Sony (®) Reader. Further background prior art can be found in: US2007/0028086, US2007/0115258, U.S. Pat. No. 7,058,829, EP0283235A, GB2214342A, and U.S. Pat. No. 6,831,662. Further background prior art relating to document security can be found in US2009/172408; U.S. Pat. No. 6,918,039; US2002/056046; U.S. Pat. No. 7,523,316; JP2009/069895; WO2007/148212; WO02/37246; and WO2007/005048.

However electronic document reading devices with electrophoretic displays present special problems because the displayed subject matter remains on the screen even when the power is removed from the device. Some aspects of this problem are considered in WO2007/111382. However, there is a need for further improved document security techniques for such electronic document reading devices.

### SUMMARY OF THE INVENTION

According to a first aspect of the invention there is therefore provided an electronic document reading device, the device comprising: a wireless remote content connection for receiving remote content over a network; a physical user interface for receiving device control commands from a user; non-volatile data storage for storing electronic document content received over said network; a non-volatile electrophoretic display screen for displaying pages of said stored electronic document content; and a device controller, coupled to said wireless remote content connection, to said physical user interface, to said non-volatile data storage, and via a display driver to said non-volatile electrophoretic display screen, wherein said device controller comprises stored program code to: read an item of electronic document content from said non-volatile data store; wherein said item of electronic document content includes: i) electronic document content display data, ii) a location based permission control object, wherein said permission control object is configured to define allowed location-based display of said content display data on said electrophoretic display screen; determine a physical location of said electronic document reading device; operate with said permission control object to determine whether display of said content display data is permitted at said physical location, wherein said operating with said permission control object enables said item of electronic document content to control whether its own content is displayed on said non-volatile electrophoretic display screen; and display said electronic document content display data on said non-volatile electrophoretic display screen response to said item of electronic document content allowing display of its content at said determined physical location.

In some embodiments the location-based permission control object of the electronic document may comprise an executable code wrapper for the electronic document content display data (the display data is data defining material to be displayed on the electrophoretic display screen). In other embodiments the item of electronic document content comprises the content display data linked to or in association with rules or permission data which accept as input a use-context for the displayed content and provide as an output data indicating whether permission is provided to display the material corresponding to the content display data.

In embodiments the storage program code includes code to determine the physical location of the electronic document reading device from identity or access control data read from the network and/or data characteristic of the wireless remote content connection. However in other embodiments a location detection system, for example a

GPS system is incorporated into the device and used, for example in conjunction with a map of permitted display locations (which map may be part of the item of electronic document content) to determine whether to the associated material is permitted to be displayed on the permanent display screen of the device. Examples of network and/or wireless connection based location identification include determination of a location based upon a network or security identification, a base station or access point identification, a VPN (virtual private network) identification, a mobile phone network cell identification, in particular for a femto cell or pico cell type network, and more generally techniques based upon signal strength, relative signal strength, signal-to-noise ratio, measured bit error rate and the like. In still other implementations one or more location change gateways may be provided in an environment in which the device is to be used, for example RFID (radio frequency identification)—type gateways so that it may be determined when the device is moved from, say, a trusted to an untrusted location. Thus in embodiments the electronic document reading device includes one or more modules to connect to one or more such wireless networks.

In still other embodiments other types of wireless network connections such as a Zigbee ™ or Bluetooth ™ type connection may be employed for location determination. With still further implementations the device may incorporate an accelerometer or similar motion and/or origination detection device and a change of physical location may be determined based upon detected motion for more than a threshold time duration and/or upon a detected orientation of the device, for example a change between approximately flat, say up to 45° inclination, and generally vertical, say + or −15°, 30° or 45°).

In embodiments the electronic document reading device also includes code to determine or identify a change in physical location of the device and, in response to this change determination, re-operate with the permission control object on the updated location. Then if the electronic document control object forbids display of its content at the updated physical location the actual document reading device explicitly writes blanking data over the otherwise permanently displayed content, to update part or all of the material displayed on the electrophoretic screen in response to the identified change in physical location.

In a related aspect the invention provides an electronic document reading device, the device comprising: a remote content connection for receiving remote content over a network; a physical user interface for receiving device control commands from a user; non-volatile data storage for storing electronic document content received over said network; a non-volatile electrophoretic display screen for displaying pages of said stored electronic document context; a device controller, coupled to said remote content connection, to said physical user interface, to said non-volatile data storage, and via a display driver to said non-volatile electrophoretic display screen, wherein said device controller includes stored program code to: read an item of electronic document content form said non-volatile data store, wherein said item of electronic document content includes: i) electronic document content display data, ii) a location based permission control object, wherein said permission control object is configured to define allowed context-based display of said content display data on said electrophoretic display screen; determine a context of operation of said electronic document reading device; operate with said permission control object to determine whether display of said content display data is permitted in said determined context, wherein said operating with said permission control object enables said item of electronic document content to control whether its own content is displayed on said non-volatile electrophoretic display screen in said determined context; and display said electronic document content display data on said non-volatile electrophoretic display screen responsive to said item of electronic document content allowing display of its content in said determined context.

In embodiments the context comprises a determined location of the electronic document reading device, but the context may additionally or alternatively include a time or time-of-day or calendar interval dependent document contents display limitation, optionally further dependent upon a user or user group and/or device or device group. In still other embodiments a permission-control context may be identified by identifying which one or more other electronic document reading devices the device is able to communicate with either directly or, more preferably, via the wireless connection. (A skilled person will appreciate that, in part, the wireless nature of the connection in combination with the permanent electrophoretic display screen creates special security problems).

A skilled person will appreciate, however, that in embodiments of the above described techniques the content (rather than the user or device) uses the available context to decide whether or not to allow its display.

In a further rated aspect the invention provides a data carrier carrying an electronic document for an electronic document reading device, wherein said electronic document comprises: i) electronic document content display data, ii) a location based permission control object, wherein said permission control object is configured to define allowed location-based display of said content display data on an electrophoretic display screen of said electronic document reading device.

The carrier may be, for example, a disk, CD- or DVD-ROM, or programmed memory such as read-only memory (Firmware). The data and/or code (or rules) may include program code such as source, object or executable code in an interpreted or compiled language, or assembly code. As the skilled person will appreciate such data and/or code may be distributed (in a linked fashion) between a plurality of coupled components in communication with one another.

In a further related aspect the invention provides a method of controlling the display of an item of content displayable on an electronic reading device, the electronic reading device comprising an electrophoretic display, the method comprising: reading one or more rules defining permissions dependent on a scenario for displaying said item of content on said electrophoretic display; determining from said one or more rules if said item of content is permitted to be displayed on said electrophoretic display in a first said scenario; writing data defining said permitted item of content to said electrophoretic display to display said permitted item of content, wherein display of said permitted item of content is continued on said electrophoretic display when said electrophoretic display is not powered; detecting a change in said scenario of said electronic reading device from said first said scenario to a second said scenario, wherein in said second said scenario said one or more rules defining said permissions do not permit said content to be displayed on said electrophoretic display; powering said electrophoretic display in response to said change in said scenario; and writing data defining obscuring content to said electrophoretic display to obscure said item of content displayed on said electrophoretic display dependent on said one or more rules.

In a further related aspect the invention provides an electronic reading device, the device comprising: an electrophoretic display; a controller coupled to said display for controlling displaying of content on said electrophoretic display; wherein said controller is configured to: read one or more rules defining permissions dependent on a scenario for displaying said item of content on said electrophoretic display; determine from said one or more rules if said item of content is permitted to be displayed in a first said scenario; write data defining said permitted item of content to said electrophoretic display to display said permitted item of content, wherein display of said permitted item of content is continued on said electrophoretic display when said electrophoretic display is not powered; detect a change in said scenario of said electronic reading device from said first said scenario to a second said scenario, wherein in said second said scenario said item of content is not permitted to be displayed on said electrophoretic display; power said electrophoretic display responsive to said change in said scenario; and write data defining obscuring content to said electrophoretic display to obscure a non-permitted item of content displayed on said electrophoretic display dependent on said rules.

In embodiments when an item of content has been obscured after a change in context/scenario, when rules then indicate that content can no longer be displayed, the item of content cannot be redisplayed (permitted) again until a user actively permits (e.g. with a password). This prevents the obscured content from becoming visible again until explicitly requested by the user (in embodiments an encrypted lock is placed on the obscured content). This feature may also be part of the rules, so that the rules indicate an action to be performed (for example displaying content or implementing a change in display permission(s)) on a change of context/scenario from non-permitted to permitted. This action may be document/content-dependent and/or user-dependent, for example permitting display subject to an explicit user command (and/or removing an encrypted lock on the content).

### BRIEF DESCRIPTION OF THE DRAWINGS

These and other aspects of the invention will now be further described by way of example only, with reference to the accompanying figures in which:

FIGS. 1a to 1c show, respectively, a front, display face view, a rear view, and a vertical cross-section view of an electronic document reading device according to an embodiment of the invention;

FIG. 2 shows a detailed vertical cross-section through a display portion of the device of FIG. 1;

FIG. 3 shows a block diagram of control electronics for an electronic document reader, the inset shows a flow diagram of a simple document display procedure;

FIG. 4 shows a conceptual diagram illustrating how an item of electronic document content uses location data to control display of its own content;

FIGS. 5a to 5b show, respectively, examples of an item of electronic document content including a context-based permission control object;

FIG. 6 shows a flow diagram of a procedure for a controller of an electronic document reading device according to an embodiment of the invention; and

FIG. 7 shows a block diagram of a power management system for electronic document reading device according to an embodiment of the invention.

### DETAILED DESCRIPTION OF PREFERRED EMBODIMENTS

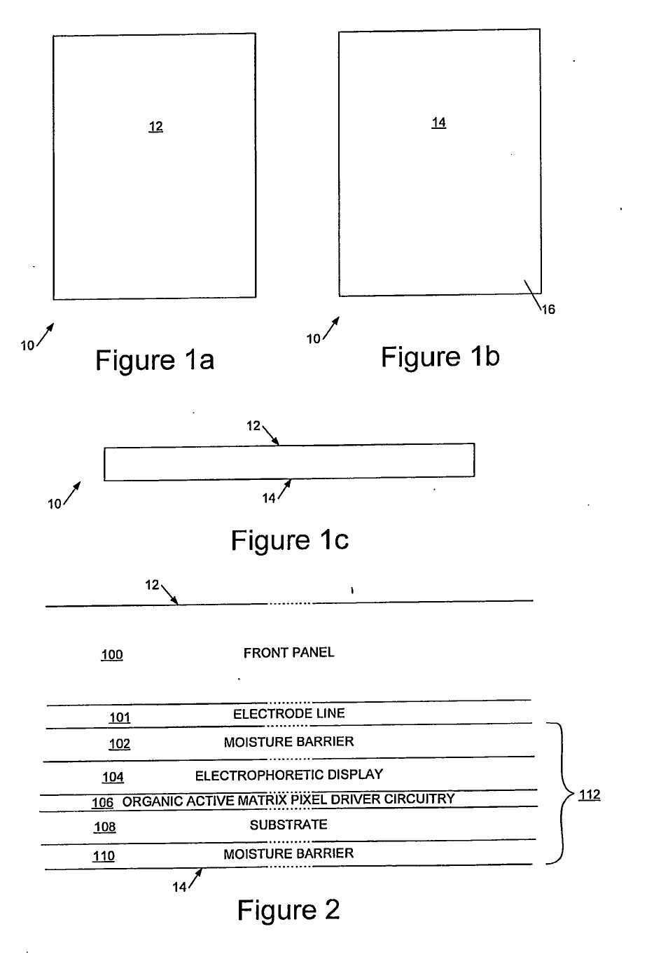

Referring to FIGS. 1a to 1c, these schematically illustrate an electronic document reading device 10 having a front display face 12 and a rear face 14. As can be seen from FIG. 1c, in preferred embodiments the display surface 12 is substantially flat to the edges of the device, although in embodiments the electrophoretic display does not extend right to the edges of the display surface 12, and rigid control electronics are incorporated around the edges of the display. This approach reduces the overall thickness of the device and thus facilitating flex-tolerance, at the expense of making the overall area of the device slightly larger.

Referring now to FIG. 2, this illustrates a vertical cross-section through a display region of the device between the frame members 16. The drawing is not to scale.

As can be seen, in preferred embodiments the device has a substantially transparent front panel 100, for example made of Perspex (®), which acts as a structural member. The active matrix pixel driver circuitry layer 106 may comprise an array of organic or inorganic thin film transistors as disclosed, for example, in WO01/47045. However such a front panel is not necessary—sufficient physical stiffness could be provided, for example, by the substrate 108 optionally in combination with one or both of the moisture barriers 102, 110.

The illustrated example of the structure comprises a substrate 108, typically of plastic such as PET (polyethylene terephthalate) on which is fabricated a thin layer 106 of organic active matrix pixel driver circuitry. Attached over this, for example by adhesive, is an electrophoretic display 104, although alternative display media such as an organic LED display medium or liquid-crystal display medium may also be used. A moisture barrier 102 is provided over the electronic display 104, for example of polyethylene and/or Aclar ™, a fluoropolymer (polychlorotrifluoroethylene-PCTFE); preferably this incorporates an ultraviolet (UV) filter—many suitable UV-filtering plastic materials are available commercially. Additionally or alternatively a UV filtering or blocking layer of adhesive may be included between one more of the layers shown in FIG. 2. A moisture barrier 110 is also preferably provided under substrate 108; since this moisture barrier does not need to be transparent preferably moisture barrier 110 incorporates a metallic moisture barrier such as a layer of aluminium foil. This allows the moisture barrier to be thinner, hence enhancing overall flexibility.

As illustrated, conductive electrode lines 101, such as ITO, for touch sensing are located behind the front panel of the device, although in alternative implementations they may be located elsewhere. A set of transparent touch screen electrodes may be laminated onto the display medium and display backplane (using a pressure sensitive adhesive). Embodiments of the device thus incorporate a (projected) capacitive touch sensitive electrophoretic display, which may be used to identify gestures for selecting documents and/or pages, turning pages forward and back and the like.

Approximate example thicknesses for the layers are as follows: 100 μm for moisture barrier 110, 200 μm for substrate 108, 5-6 μm for active layer 106, 190 μm for display 104, and 200 μm for moisture barrier 102. The set of layers 102-110 form an encapsulated electronic display 112; preferably this is bonded, for example by adhesive, to a touch sensor, and a transparent display panel 100. The front panel 100 may have a thickness in the range 0.1-2 mm, for example approximately 1 mm or approximately 0.2 mm.

In embodiments the display edging is coloured to substantially match the colour of the active display area 104, which gives the appearance that the reader is a single display extending to the edges of the reader device. The display edging may comprise a simple border which may be, for example, sprayed onto the front panel or it may comprise an additional, undriven sheet of electrophoretic display or an undriven lateral extension of the electrophoretic display.

In embodiments, the electronic document reader comprises connectors located along an edge of the device to enable the device to be connected to other electronic devices, such as a laptop or desktop computer, a PDA (Personal Digital Assistant), a mobile phone or ‘smart’ phone, or other such devices. A USB (universal serial bus) or similar connector is, for example, provided. However, in embodiments, the electronic document reader may also be provided with wireless interfaces (for example a infrared or Bluetooth™ or other such interfaces). Such connections enable documents to be transferred to and from the electronic document reader.

The device may also include a number of user controls for selecting documents and/or pages, turning pages forward and back and the like. In embodiments, the border around the active display comprises touch sensitive elements. However in other embodiments the display may be touch sensitive, for example as described in our co-pending international patent application PCT/GB2006/050220 hereby incorporated by reference in its entirety. Such sensors may include capacitive sensors or resistive touch sensors. The aforementioned patent application describes an arrangement in which a touch-screen component is positioned below the display, but which is nonetheless operable from the front, display surface, in particular by laminating the display medium and display backplane over a resistive touch-screen (using a pressure sensitive adhesive). However the skilled person will appreciate that other forms of touch-screen technology may additionally or alternatively be employed. In such embodiments, documents may be electronically “marked-up”, with mark-up data being written to or being associated with the electronic document being displayed.

As mentioned, in preferred embodiments the display medium is a reflective display medium, in particular an electrophoretic display medium and the backplane comprises a flexible substrate such as PET or PEN (polyethylene naphthalene). Preferably the backplane is fabricated using solution-based transistors preferably patterned by techniques such as direct-write printing, laser ablation or photolithography. Further details can be found in the applicant's earlier patent applications, including, in particular, WO 01/47045, WO 2004/070466, WO 01/47043, WO 2006/059162, WO 2006/056808, WO 2006/061658, WO 2006/106365 and PCT/GB2006/050265, all hereby incorporated by reference in their entirety.

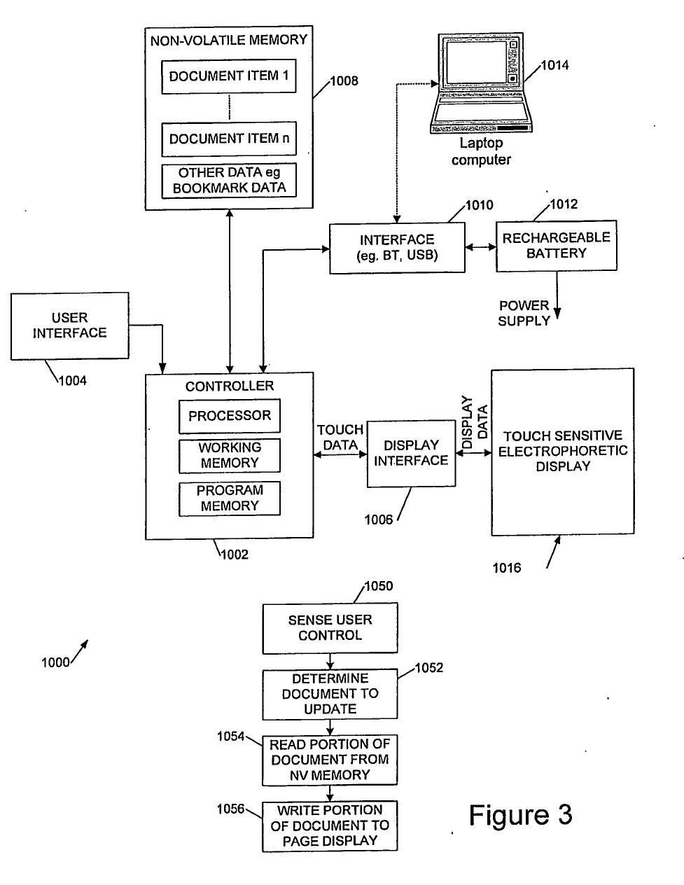

Referring now to FIG. 3, this shows example control circuitry 1000 suitable for the above-described electronic document reader 10. The control circuitry comprises a controller 1002 including a processor, working memory and programme memory, coupled to a user interface 1004 for device controls. The controller is also coupled to via a display interface 1006 to an active matrix electrophoretic display 1016. In this way controller 1002 is able to send electronic document data to the display 104 and, optionally, to receive touch-sense data from the display. The control electronics also includes non-volatile memory 1008, for example Flash memory for storing data for one or more document items for display each including a permission control object, and optionally other data such as user bookmark locations and the like. An external interface 1010 is provided for interfacing with a computer such as laptop, PDA, or mobile or ‘smart’ phone 1014 to receive document data and, optionally, to provide data such as user bookmark data. The interface 1010 may comprise a wired, for example USB, and/or wireless, for example Bluetooth™ interface and, optionally, an inductive connection to receive power. The latter feature enables embodiments of the device to entirely dispense with physical electrical connections and hence facilitates inter alia a simpler physical construction and improved device aesthetics as well as greater resistance to moisture. A rechargeable battery 1012 or other rechargeable power source is connected to interface 1010 for recharging, and provides a power supply to the control electronics and display.

The skilled person will appreciate that processor control code for a wide range of functions may be stored in the programme memory. By way of example a simple document display procedure may comprise, in operation, sensing 1050 a user control, determining which document to update 1052, reading a portion of the relevant document from the non-volatile memory 1054, and writing the read portion of the document to the page display 1056. We will describe later, a more sophisticated display procedure implementing an embodiment of an aspect the invention.

As discussed above, electronic documents to be displayed on the reader may come from a variety of sources, for example a laptop or desktop computer, a PDA (Personal Digital Assistant), a mobile phone (e.g. Smart Phones such as the Blackberry™), or other such devices. Using the wired (e.g. USB etc) or wireless (e.g. Bluetooth™) interfaces, the user can transfer such electronic documents to the document reader in a variety of ways. Electronic documents may comprise any number of formats including, but not limited to, PDF, Microsoft Word™, Bitmaps, JPG, TIFF and other known formats.

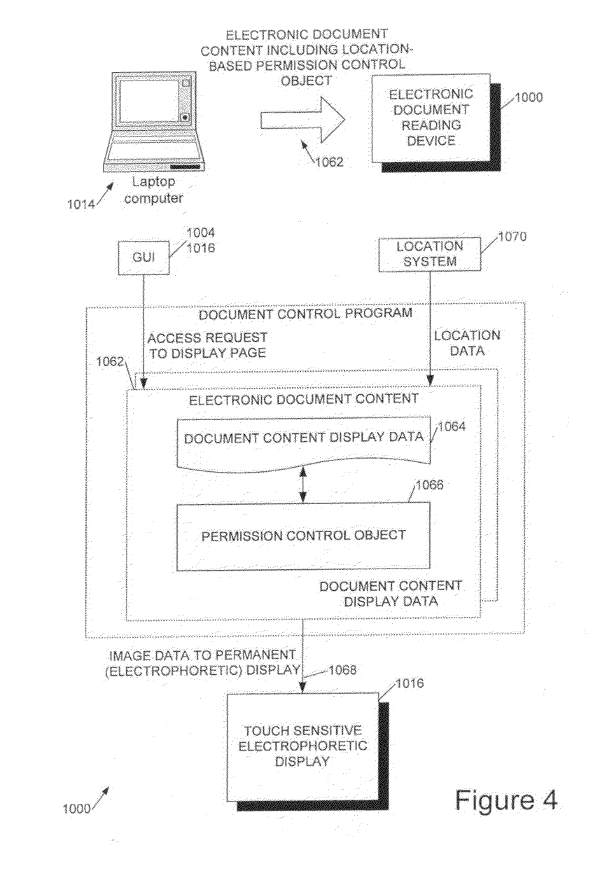

Referring now to FIG. 4, this illustrates, conceptually, an embodiment of the above described electronic document reading device 1000 in which an item of electronic document content (rather than the user or device) uses the available context to decide whether or not to permit its own display. As illustrated laptop computer 1014 provides an item of electronic document content 1062 to the reading device, the item comprising the document content display data 1064 and a location-based permission control object 1066. Which, in embodiments, interacts with or controls display of the document content display data. Within the document reading device 1000 a graphical user interface 1004, 1016 provides an access request to document item 1062 and a location system 1070 provides location data to the document item. The document item then processes the location data, in cooperation with a document control program 1060, to determine whether or not to allow display of its document content and, if display is permitted, outputs image data 1068 for display on the touch sensitive electrophoretic display 1016.

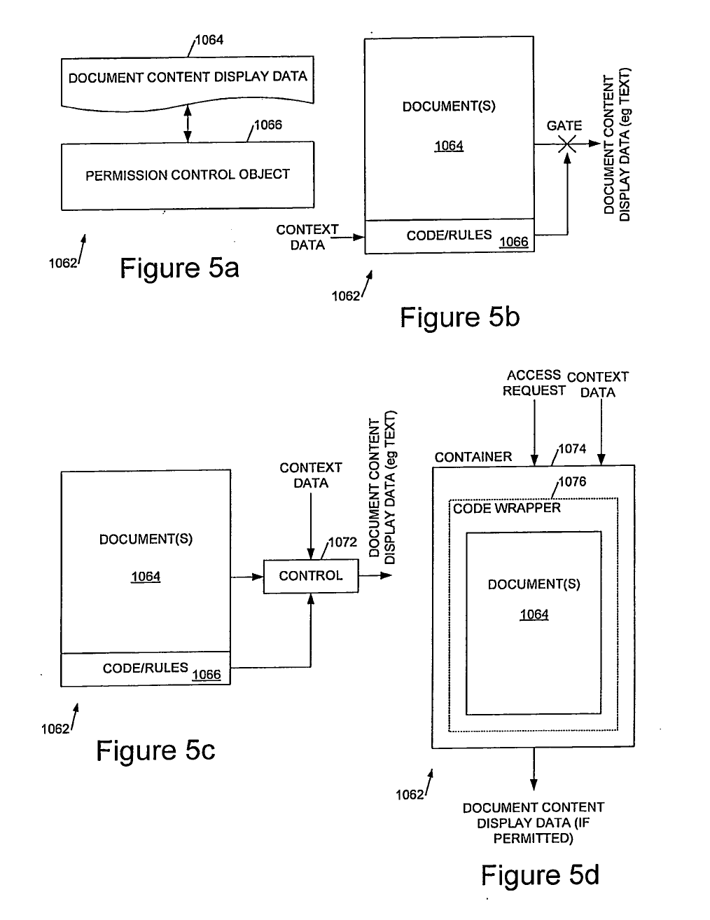

Referring now to FIG. 5, this shows examples of alternative items of electronic document content which may be employed in embodiments of the above described electronic document reading device 1000. FIG. 5a shows the conceptual item of document content of FIG. 4; FIG. 5b shows an example in which executable code and/or rules are associated with or appended to one or more documents to operate on context data and provide an output used to control a gate which gates the output of document content display data from documents 1064. In FIG. 5b the context data is processed by the code/rules in the item of electronic document content; in FIG. 5c a separate control module 1072 is provided. In FIG. 5d the item of electronic document content 1062 comprises a container 1074 including a code wrapper 1076 for one or more documents 1064. The code wrapper 1076 processes the access request and context data and the container 1074 outputs document content display data, such as text, if display is permitted. In preferred embodiments the context data comprises location data but additionally or alternatively other types of context data may be employed.

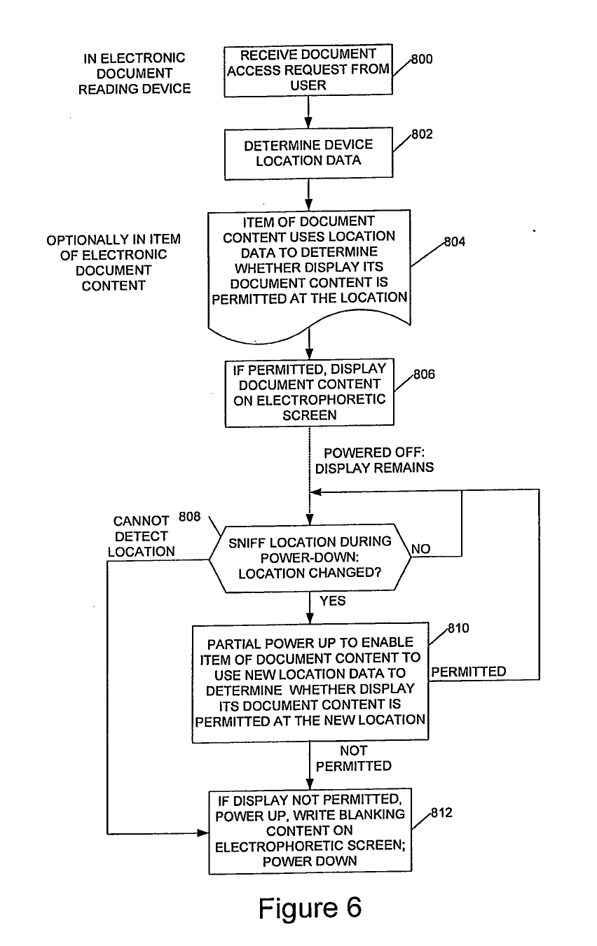

Referring now to FIG. 6, this shows a procedure which may be implemented by controller 1002 of electronic document reading device 1000 to control content display as described in the Summary of the Invention. Thus at step 800 the procedure receives a document access request from a user and determines device location data (step 802) identifying a physical location of the electronic document reading device. Then, at step 804, the item of electronic document content uses this location data to determine whether display of the document content is permitted at the location, for example by executing the associated permission control object to operate on the location data to determine whether display of the content is permitted at the location. This may be performed by code and/or rules in the item of electronic document content or by program code forming part of the stored program code of the electronic document reading device.

Then, at step 806, if display is permitted the content is written to the electrophoretic display screen.

In the illustrated example procedure, sometime after the user has finished interacting with the device, the device powers down into a standby state (as described further below, in embodiments the main processor of the document reading device is switched off during this state), but because of the nature of the electrophoretic display screen the displayed content remains on the screen. At step 808 a wireless network interface of the device is briefly powered up at intervals to sniff data capable of determining a location of the device. This may be a detailed, 3D location or a relatively course location determined, for example, by whether the device is able to connect to a local wifi, Bluetooth™ or other network. If the location is not determined to have changed the device continues to sniff for presence of a wireless network at intervals, but if the location has changed the procedure continues to step 810, to failsafe, if a previously connected wireless network can no longer be found the procedure may continue directly to step 812 to blank the non-volatile display screen.

At step 810 the device performs at least a partial power up to enable the item of document content to operate on the new location data to determine whether display of the document content is permitted at the new location if display is permitted the procedure once again loops back; if not the non-volatile display is blanked (step 812) by explicitly writing blanking content to the electrophoretic display screen, in embodiments writing a background colour of the screen over the previously permanently displayed data. The device then powers down as it is now safe.

### Power Management

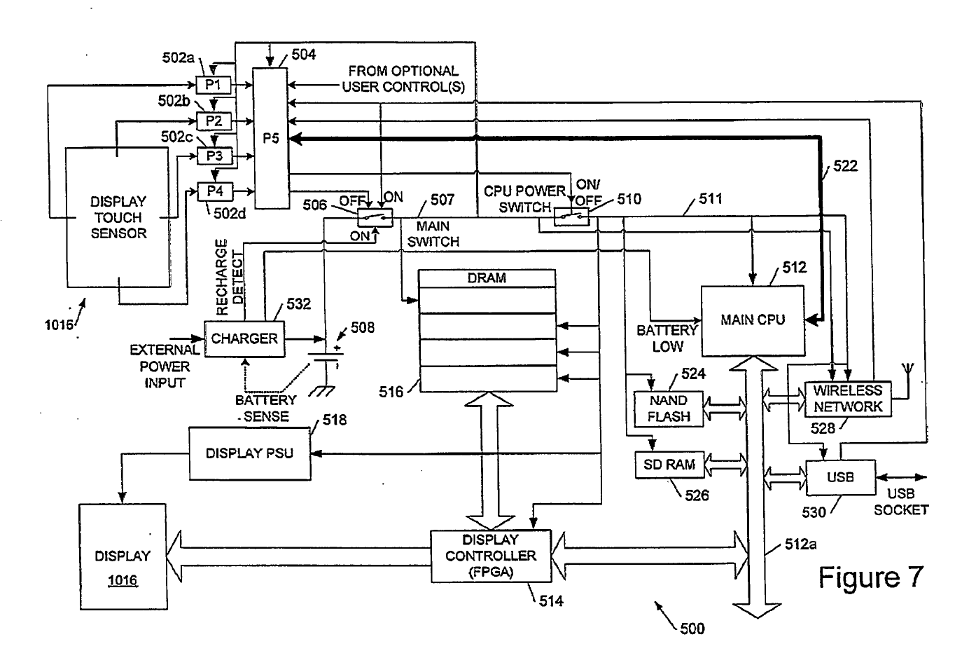

Referring now to FIG. 7, this shows preferred power management architecture 500 for an electronic document reading device incorporating a context (location)—based content system as described above.

The electronic document reading device includes a touch sensitive display 1016, as previously described. This enables the user to control the device through touch and/or gesture; in embodiments no power on/off switch or control is needed. In preferred embodiments data from the touch sensing electrodes is processed by a set of dedicated processors 502a-d, one per side of the display, in embodiments PSoC (Registered Trade Mark) microcontroller devices available for example from Cypress Semiconductor Corporation. Each of these provides an input to a further, control processor 504 via a serial I2C bus, in embodiments an AVRmega48 device from Atmel (Registered Trade Mark) Corp, which includes on-chip Flash, RAM, and EEPROM. Processor 504 processes data from the touch sensing processors to integrate this data and make touch decisions (as described in more detail below), as well as to identify gesture primitives and/or gestures, and provides processed touch sensed information to a main CPU (Central Processing Unit) 512 of the electronic document reading device via a bi-directional serial bus 522, for example an SPI bus. Processor 504 also provides a number of power control functions, described below.

The touch sensitive display may respond to a conductive stylus and/or a finger. In embodiments XY location data from the processors 502a-d can be passed to the main processor 512 in addition to recognised gesture or gesture primitive data, to enable a user to write on the display with a stylus and the CPU 512 to processes this data and provides it to the display controlled 514 for display, for annotation of a document.

Power for the electronic document reading device is provided from a rechargeable battery 508, for example a 3 volt lithium battery, via a main switch 506 which switches power on and off to the entire device. The switch 506 has at least one control input for controlling the switch on and off and in embodiments comprises a low-on-resistance CMOS switch, more generally a solid state switch such as a MOS-FET switch. A first power supply bus 507 provides the switched power from the main switch a secondary, CPU power switch 510, again comprising a controllable CMOS switch, which in turn provides power to a second, switched power bus 511.

The electronic document reading device includes a main CPU 512, for example an ARM (Registered Trade Mark) device having a bus 512a coupling the device to NAND Flash 524, SD RAM 526, a wireless network interface 528, and a USB interface 530 as well as, optionally, to other peripheral devices. bus 512a also couples the main CPU 512 to a display controller at 514, for example implemented as an FPGA (Field Programmable Gate Array) or ASIC (Application Specific Integrated Circuit), which in turn drives display 32. In embodiments the CPU and display controller are implemented on a single chip for example using a customisable microcontroller such as an Atmel CAP 9 series, the display controller being implemented using an on-chip programmable block.

The display has a dedicated display power supply unit 518 to provide the relatively high voltages used to drive the electrophoretic display from the battery 508. In the illustrated embodiment the display controller 514 is coupled to dynamic RAM 516 comprising blocks of memory at least one of which has its own, separate power supply. The DRAM 516 stores data for display controller 514 and has a portion for storing data representing a current state of the electrophoretic display which has a separately switchable power supply; memory 516 may physically comprise either a single memory device or multiple separate memory devices.

In FIG. 7 power supply rails are shown with triangular arrow heads and signal/control lines are shown using arrow heads with a slightly indented rear. Thus it can be seen that power bus 511, as well as providing a power to the main CPU 512, also provides a power supply to memory elements 524, 526, peripheral devices 528, 530, to the display controller 514 and display power supply 518, and to a first part of the display memory 516. The main power supply bus 507 provides power to a second part of the display memory, to processors 502a-d and to processor 504 (which provide touch-sense and power management functions). This power supply bus also provides a second power supply to a wireless network interface 528, for example a Bluetooth and/or WiFi interface. A charger 532 has a wired or wireless external power input and operates to charge battery 508, as well as providing a battery status sense function and a low battery output signal to the main CPU 512 (in other embodiments such a battery status sense function may be provided in different ways). The charger 523 also provides a recharge detect signal, as illustrated to main switch 506, but in other embodiments this may be configured differently, for example to provide a signal to process 504.

Broadly speaking, in operation processor 504 controls the CPU power switch 510 to switch on and off power to the main CPU, the CPU memory and peripherals, the display RAM, display controller and display power supply only when it is needed for example in response to a user request for a page turn. To provide a long battery life, preferably of order months, since even the leakage current through the CPU is unacceptably high rather than put the main CPU 512 into a standby state, the power supply is entirely removed from the CPU and from as many of its associated elements as possible. However preferably a power supply is maintained to the second part of DRAM 516, which stores data representing a current state of the electrophoretic display. As power to the entire CPU is turned off, when the power is re-applied the main CPU by definition performs a cold boot which is potentially a slow process. It is therefore preferable to minimise the delay between re-applying power to the CPU and performing the desired user action, and storing a current state of the electrophoretic display helps to achieve this. When the desired user action has been performed, in embodiments the processor performs a cold boot in response to the user action. Thus if desired the power to the CPU can simply be removed without prior notification to the CPU—that is a handshaking process requesting power down and having the CPU acknowledged that a power down can take place is not necessary.

In the illustrated embodiment, elements of the system which are not powered down by the CPU power switch 510 are the secondary processor 504 and the touch/gesture processors 502, so that the document reading device remains sensitive to a user touch/gesture when the main CPU is switched off. Alternatively, however, processor 504 may have one or more inputs from buttons or switches on the device to enable the main CPU to be restarted.

When the CPU power switch 510 is off, preferably power is still applied to the wireless network interface 528. Thus in embodiments, the wireless network interface system has two power supplies, one to power the main system and a second, derived from bus 507, to provide a minimal amount of power to the wireless network interface to provide a wireless network ‘sniffing’ function, powering on a receiver at intervals to check the wireless network signal.

More particularly, if this signal indicates a change in location the wireless network interface may then send a signal to one or both of the secondary and main processor to power up (or partially power up) the device. In embodiments the wireless network interface system 528 provides a signal to processor 504 when a compatible RF signal is detected, and processor 504 can then control switch 510 to switch the main CPU on. In this way the device can be configured to automatically power up and connect to a wireless network when one is present, in particular to perform a context-determination operation to determine one or more characteristics of a local operating environment, such as an operating location. This feature may also be used to perform other functions, for example automatic synchronisation when the device is brought into proximity with a wireless-enabled host computer system or network and/or mobile communications network.

Once the device has been powered up, or partially powered up, the displayed item of document content can operate on data indicating the new location to determine whether it is still permitted to display the document content. If it is permitted, the device can power down once again; if not blanking data can be written to the (non-volatile) display before powering down. Preferably the device defaults to a “safe” condition, that is, if it is not possible to determine a new location but it can be determined that a location has changed (for example by absence of a wireless network signal that was previously present), the device is configured to fail safe, and blank the (or a relevant part of) displayed document content.

In this way the electronic document reading device is able to perform a wireless network-based location determination even when effectively powered down. Additionally or alternatively a positioning system such as a GPS (Global Positioning System)—type module (not shown) may be incorporated into the device to obtain absolute or differential location information. This may location data may then be processed by the item of document content to determine whether display of its content is permitted.

Preferred embodiments of the electronic document reading device also include a main switch 506 configured to switch power on and off to the entire document reading device, for example in response to detection that the battery 508 is low. There are many different possible signal routes which could be employed. As illustrated charger 532 senses a condition of the battery and provides a signal to the main CPU 512 which either directly, or via processor 504, controls the main switch 506 off. However in other arrangements a charger 532 could directly control the main switch 506 off, or this control could be performed via a loop including processor 504 but not main CPU 512. The main switch 506 may be switched on, for example, by detection of recharging of the electronic document reading device and/or by a USB power detect function provided by USB interface 530 which detects when power is available from the connected USB socket. In embodiments this power source may additionally or alternatively be employed to recharge battery 508.

The skilled person will understand that, in this specification, “document” is used broadly since the techniques we describe are applicable to any information on a page, not just words, including for example, pictures, music and in general any material which may be printed to a page. Thus references to pages of a document are to be interpreted broadly and may include, for example, web pages, e-mails, image pages and many other types of document, for example music scores. It will also be understood that embodiments of the device we describe may be used for writing as well as reading, for example to annotate a page which is being read.

No doubt many other effective alternatives will occur to the skilled person. It will be understood that the invention is not limited to the described embodiments and encompasses modifications apparent to those skilled in the art lying within the scope of the claims appended hereto.

1. An electronic document reading device, the device comprising:
a wireless remote content connection for receiving remote content over a network;
a physical user interface for receiving device control commands from a user;
non-volatile data storage for storing electronic document content received over said network;
a non-volatile electrophoretic display screen for displaying pages of said stored electronic document content; and
a device controller, coupled to said wireless remote content connection, to said physical user interface, to said non-volatile data storage, and via a display driver to said non-volatile electrophoretic display screen, wherein, said device controller comprises stored program code to:
read an item of electronic document content from said non-volatile data store;
wherein said item of electronic document content includes:
i) electronic document content display data,
ii) a location based permission control object, wherein said permission control object is configured to define allowed location-based display of said content display data on said electrophoretic display screen;
determine a physical location of said electronic document reading device;
operate with said permission control object to determine whether display of said content display data is permitted at said physical location,
wherein said operating with said permission control object enables said item of electronic document content to control whether its own content is displayed on said non-volatile electrophoretic display screen; and
display said electronic document content display data on said non-volatile electrophoretic display screen response to said item of electronic document content allowing display of its content at said determined physical location.

2. An electronic document reading device as claimed in claim 1 wherein said permission control object comprise a executable code wrapper for said electronic document content display data.

3. An electronic document reading device as claim 1, wherein said code to determine a physical location of said electronic document reading device comprises code to determine said physical location from identity or access control data read from said network.

4. An electronic document reading device in claim 1, further comprising code to: determine a change of said physical location and, responsive to said change determination, re-operate with said permission control object on an updated said physical location, and write blanking data to said non-volatile electrophoretic display screen responsive to said electronic device control object forbidding display of its content at said updated physical location.

5. An electronic document reading device as claimed in claim 4 further comprising a device control processor to control writing of said electronic document content display data to said electrophoretic display, and a power management system to remove power from said display control processor when said electronic document reading device is not being operated, wherein said wireless remote content connection has a power supply controllable separately to said power to said display control processor, wherein said electronic document reading device is configured to control said wireless remote content connection to check a signal from said network at intervals, and wherein said code further comprises code to: power up said device control processor responsive to said change determination to re-operate with said permission control object on said updated physical location, and to write said blanking data if necessary.

6. An electronic document reading device as claimed in claim 4, wherein said code to write said blanking data is configured to write said blanking data responsive to said electronic document reading device being able to determine that a said change of physical location has occurred and being unable to determine said updated physical location.

7. An electronic document reading device as claimed in claim 1, wherein said code to determine a physical location of said electronic document reading device comprises code to determine said physical location from a characteristic of said wireless remote content connection.

8. An electronic document reading device, the device comprising:
a remote content connection for receiving remote content over a network;
a physical user interface for receiving device control commands from a user;
non-volatile data storage for storing electronic document content received over said network;
a non-volatile electrophoretic display screen for displaying pages of said stored electronic document context;
a device controller, coupled to said remote content connection, to said physical user interface, to said non-volatile data storage, and via a display driver to said non-volatile electrophoretic display screen, wherein said device controller includes stored program code to:
read an item of electronic document content form said non-volatile data store,
wherein said item of electronic document content includes:
i) electronic document content display data,
ii) a location based permission control object, wherein said permission control object is configured to define allowed context-based display of said content display data on said electrophoretic display screen;
determine a context of operation of said electronic document reading device;
operate with said permission control object to determine whether display of said content display data is permitted in said determined context,
wherein said operating with said permission control object enables said item of electronic document content to control whether its own content is displayed on said non-volatile electrophoretic display screen in said determined context; and
display said electronic document content display data on said non-volatile electrophoretic display screen responsive to said item of electronic document content allowing display of its content in said determined context.

9. An electronic document reading device as claimed in claim 8 wherein said context comprises data identifying a location of said electronic document reading device.

10. A data carrier carrying an electronic document for an electronic document reading device, wherein said electronic document comprises:
i) electronic document content display data,
ii) a location based permission control object, wherein said permission control object is configured to define allowed location-based display of said content display data on an electrophoretic display screen of said electronic document reading device.

11. A method of controlling the display of an item of content displayable on an electronic reading device, the electronic reading device comprising an electrophoretic display, the method comprising:
reading one or more rules defining permissions dependent on a scenario for displaying said item of content on said electrophoretic display;
determining from said one or more rules if said item of content is permitted to be displayed on said electrophoretic display in a first said scenario;
writing data defining said permitted item of content to said electrophoretic display to display said permitted item of content, wherein display of said permitted item of content is continued on said electrophoretic display when said electrophoretic display is not powered;
detecting a change in said scenario of said electronic reading device from said first said scenario to a second said scenario, wherein in said second said scenario said one or more rules defining said permissions do not permit said content to be displayed on said electrophoretic display;
powering said electrophoretic display in response to said change in said scenario; and
writing data defining obscuring content to said electrophoretic display to obscure said item of content displayed on said electrophoretic display dependent on said one or more rules.

12. A method as claimed in claim 11 further comprising sniffing a connection to a wireless communications network at intervals, and selectively powering said electrophoretic display in response to a result of said sniffing.

13. A method as claimed in claim 12, wherein said reading said one or more rules comprises reading metadata associated with said item of said content, said metadata defining said one or more rules associated with said item of said content.

14. A method as claimed in claim 13, wherein said item of said content comprises said metadata.

15. A method as claimed in claim 11, wherein said one or more rules are stored locally to said electronic reading device.

16. A method as claimed in claim 11, wherein said one or more rules are stored on a remote server and said reading comprises remotely accessing said remote server to retrieve said one or more rules.

17. A method as claimed in claim 11, wherein said reading said one or more rules comprises comparing a previous version of said one or more rules and said one or more rules to determine if said one or more rules have changed.

18. A method as claimed in claim 11, wherein:
said one or more rules comprise permissions dependent on a location of said electronic reading device, and
said determining comprises determining if said item of content is permitted to be displayed at a currently identified location of said electronic reading device.

19. A method as claimed in claim 11, wherein
said one or more rules comprise time dependent permissions, and said determining comprises determining if said content is permitted to be displayed at a point in time.

20. A method as claimed in claim 11, wherein said item of content comprises said one or more rules associated with said item of said content, and wherein:
said one or more rules comprise permissions dependent upon a duration said content is presented on said electrophoretic display, and
said determining comprises determining if said presentation of said content has exceeded said duration said content is presented on said electrophoretic display.

21. A method as claimed in claim 11, wherein
said one or more rules define a location permitted for displaying said item of content on said electrophoretic display,
the method further comprising determining a location of said electronic reading device,
wherein said determining from said one or more rules if said item of content is permitted to be displayed in said first scenario comprises determining if said one or more rules permit said content to be displayed at said location,
wherein said writing data defining obscuring content is dependent on said one or more rules defining a location permitted for displaying said item of content.

22. A carrier carrying processor control code to, when running, implement the method of claim 11.

23. An electronic reading device, the device comprising:
an electrophoretic display;
a controller coupled to said display for controlling displaying of content on said electrophoretic display;
wherein said controller is configured to:
read one or more rules defining permissions dependent on a scenario for displaying said item of content on said electrophoretic display;
determine from said one or more rules if said item of content is permitted to be displayed in a first said scenario;
write data defining said permitted item of content to said electrophoretic display to display said permitted item of content, wherein display of said permitted item of content is continued on said electrophoretic display when said electrophoretic display is not powered;
detect a change in said scenario of said electronic reading device from said first said scenario to a second said scenario, wherein in said second said scenario said item of content is not permitted to be displayed on said electrophoretic display;
power said electrophoretic display responsive to said change in said scenario; and
write data defining obscuring content to said electrophoretic display to obscure a non-permitted item of content displayed on said electrophoretic display dependent on said rules.

24. A device as claimed in claim 23, wherein said controller is further configured to read metadata associated with said item of content, said metadata defining said one or more rules associated with said item of content.

25. A device as claimed in claim 23, further comprising a local memory store to store said one or more rules, and wherein said controller is further configured to read said local memory store to read said one or more rules.

26. A device as claimed in claim 23, further comprising an interface to communicate with a remote server.

27. A device as claimed in claim 26, wherein said reading comprises remotely accessing said remote service using said interface to retrieve said one or more rules.
